(19) United States
(12) Patent Application Publication
(10) Pub. No.: US 2008/0235924 A1
(43) Pub. Date: Oct. 2, 2008

(54) DECORATIVE SHEET METAL ORNAMENT

(76) Inventor: David Waldner, Ste. Agathe (CA)

Correspondence Address: ADE & COMPANY INC., 2157 Henderson Highway, WINNIPEG, MB, R2G1P9, CA

(21) Appl. No.: 11/694,404

(22) Filed: Mar. 30, 2007

(51) Int. Cl. A47G 35/00; B05D 3/12

(52) U.S. Cl. 29/6.1; 427/289

(57) ABSTRACT

A three dimensional decorative spinner is formed of sheet metal by cutting from a flat metal sheet and, while the cut metal sheet remains flat and after it is coated by a powder coat covering layer which is baked, different color layer or layers of different patterns are silk screen printed onto the sheet on each side. The space between each strip and the next is sufficient that the printed covering layers on each side of the strip meet so as to also cover edges of the strips at the space with the covering layers on the each strip being separated from the covering layers on the next adjacent strip by the space between the strips. After the baking of the coating and printing of the colored layer or layers at least some of the strips are bent out of the flat plane of the metal sheet with the width of each strip at the area of bending of the strip being arranged such the bending occurs without cracking the covering layers.

The present invention relates to a three dimensional decorative ornament created from flat sheet material which is preferably but not exclusively of the type which acts as a spinner arranged to be suspended for rotation.

### BACKGROUND

A multitude of three dimensional decorations have been created from sheet material by various processes including cutting, bending and painting of the material to obtain visually attractive forms.

One such decorative device is disclosed in U.S. Pat. No. 6,783,815 (Flohe) issued Aug. 31, 2004. The device comprises a series of angularly spaced strips of sheet material connected by spines at either end of said strips. The strips are formed by cutting fine lines in the metal sheet so as to simply separate each strip from the next. The strips are then separate by bending the strips out of the plane of the sheet and are preferably arranged in pairs such that the two strips in each pair are annularly displaced by 180 degrees in order to form a plane through the axis formed by the spines at either end of the strips. Each strip in the pair thereby outlines half a geometric shape on a respective side of the spines, the pair thereby together outlining a closed geometric shape in plane they define. The device is supported for rotation about the axis formed by the spines in order to create an appealing visual effect when spun.

Another arrangement is shown in Canadian application 2, 510,346 of the present Applicant which was published Dec. 1, 2006. This discloses an arrangement of the above type which is made more complex by providing a second spinner inside the first.

### SUMMARY

It is one object of the present invention to provide an improved visual effect of a three dimensional decorative device created from sheet material.

According to the present invention there is provided a method of manufacturing a decorative assembly comprising:

providing a flat sheet of metal;

cutting from the metal portions of the metal so as to form strips of the metal separated each from the next by a space from which the metal has been removed;

while the cut metal sheet remains flat, printing onto the cut metal sheet on each side a respective covering layer;

on at least one side of the cut metal sheet, the covering layer being applied in at least two separate steps each involving a different color so that the covering layer on said at least one side is formed of different colors;

the space between each strip and the next being sufficient that the printed covering layers on each side of the strip meet so as to also cover edges of the strips at the space with the covering layers on the each strip being separated from the covering layers on the next adjacent strip by the space between the strips;

bending at least some of the strips out of the flat plane of the metal sheet at an area of bending of the strips to form a three dimensional ornament;

wherein the width of each strip at the area of bending of the strip is arranged such the bending occurs without cracking the covering layers.

Preferably the coatings include a powder coat layer and a colored layer which is applied by silk screen printing process onto the powder coat layer.

Preferably the colored layer or layers are applied by silk screen printing process which requires that the sheet be flat while the printing action take place.

Preferably the coatings are baked.

Preferably on both sides the covering layer is printed in at least two separate steps each involving a different color so that the covering layer on said at least one side is formed of different colors.

Preferably the flat sheet of metal is cut to form a spinner of the type generally shown in the above published documents although other three dimensional decorative objects formed from a flat sheet which is bent to form the three dimensions can also be included.

The spinner can be of the type comprising a first spine having an axis, a first aperture near an outer end and a second aperture near an inner end; a second spine having the same axis as the first spine; a first series of progressively longer angularly spaced strips each having an inner edge, an outer edge and two opposite ends, each end connected to a respective one of the spines on a first side; and a second series of progressively longer angularly spaced strips each having an inner edge, an outer edge and two opposite ends, each end connected to a respective one of the spines on a second side; wherein the strips in each series are spaced apart by the space between the inner edge of one of said strips and the outer edge of an adjacent one of said strips; and wherein the inner edge of the strip of shortest length in the first series and the inner edge of the strip of shortest length in the second series define an opening in the outer member.

Preferably the two spines are connected to and separate by a center panel which is maintained flat.

Preferably the center panel contains different colors.

Preferably adjacent strips of the first series are angularly spaced by a generally equal first angle and adjacent strips of the second series are angularly spaced by a generally equal second angle.

Preferably the first and second angles of the inner member are generally equal.

Preferably each strip in the first series is angularly spaced from a respective strip in the second series of the inner member by about 180 degrees.

### BRIEF DESCRIPTION OF THE DRAWINGS

In the accompanying drawings, which illustrate an exemplary embodiment of the present invention:

FIG. 1 is a front elevational view of the decorative assembly prior to bending.

FIG. 2 is a cross-sectional view the decorative assembly of FIG. 1.

FIG. 3 is a top plan view the decorative assembly of FIG. 1.

### DETAILED DESCRIPTION

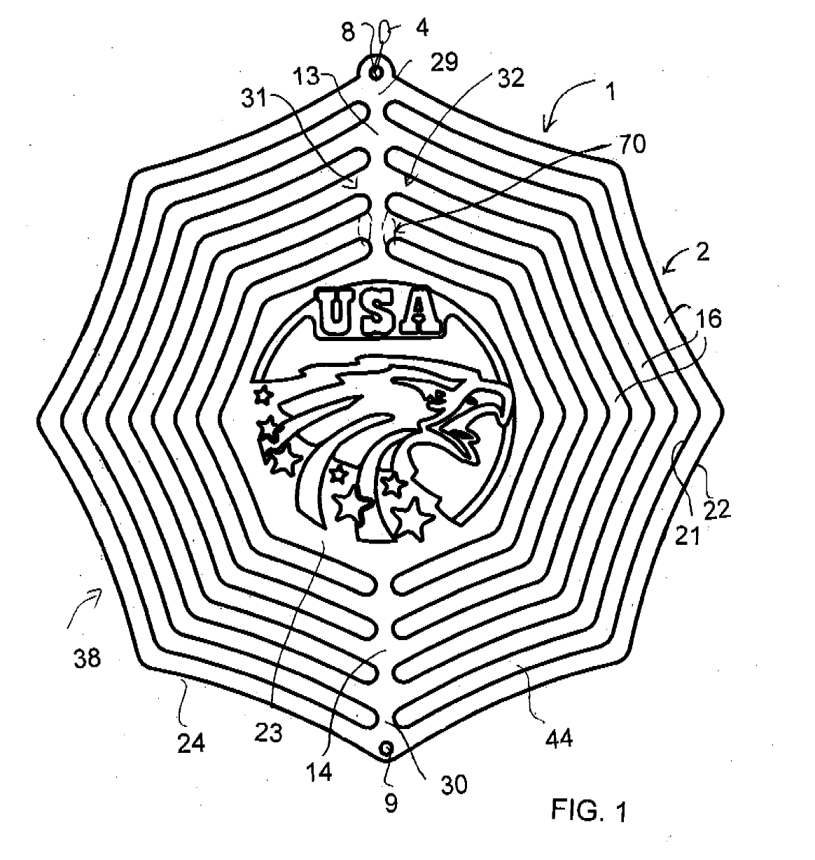

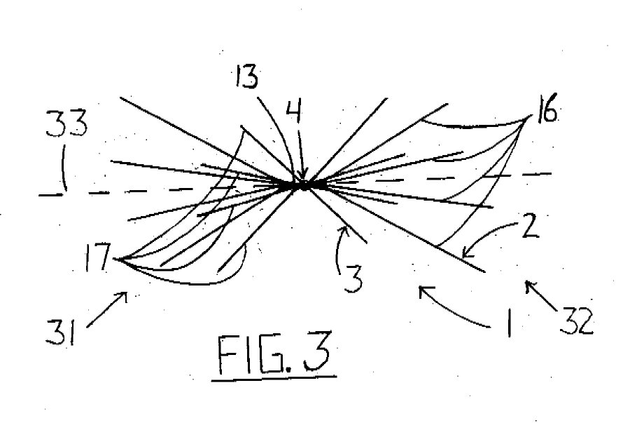

One embodiment of the present invention is shown from the front and the top in FIGS. 1 and 3 respectively. The decorative assembly 1 features a spinner member 2 suspended for rotational motion. The spinner member 2 includes a plurality of angularly spaced longitudinal strips 16 each having an inner edge 21, an outer edge 22, an upper end 29 and a lower end 30. Each strip connects to an upper spine 13 at its upper end 29, extends longitudinally between its inner edge 21 and outer edge 22 and connects to a lower spine 14 at its lower end 30. On each side of the spines, the strips 16 are progressively longer moving outward from the center of the outer member 2. The spines 13 and 14 are aligned in order to share a single vertical axis around which the spines 16 are angularly spaced. The strips are arranged such that the number of strips 16 on a first side 31 of the spines 13 and 14 is equal to the number of strips 16 on a second side 32 of said spines. The strips on the first side 31 of the spines 13 and 14 are spaced around the axis of said spines such that the angle between any two adjacent strips is the same, and the strips on the second side 32 of said spines are spaced in the same manner by the same angle. Each strip on one side of said spines has a respective strip on the opposite side from which it is angularly spaced by approximately 180 degrees. Each strip is spaced from an adjacent strip on the same side of the spines by a distance between the inner edge 21 of one strip and the outer edge 22 of the other. In other words, the strips 17 are spaced apart by the difference in their radial distance from the center of the outer member 2.

A first aperture 8 is provided in the upper spine 13 near the longest of the strips 16 on either side of said spine, allowing the outer member 2, and thus the entire decorative assembly 1, to be suspended by an outer pivotal support 4. The outer pivotal support 4 features a mounting ring for engagement to a hook or other external support device (not shown). The first aperture 8 is located on the vertical axis of the spines such that the member 2 is free to rotate about said axis. A second aperture 9 is provided on the lower spine 14, each aperture being located on the vertical axis of the spines.

The member 2 of the decorative assembly 1 is fabricated by laser cutting and bending a flat sheet of metal into the form shown in FIG. 1. The piece 38 has been cut to form a generally circular two-dimensional shape defined by an outermost edge 24 and further cut to create an innermost central flat plate 23. Cuts made between the innermost edge 23 and the outermost edge 24 create slots 44 that define the plurality of strips 16. The width of the slots 44 determines the distance between the inner edge 21 of a strip 16 and the outer edge 22 of an adjacent strip, thereby defining the spacing of the strips. A significant piece of material is removed in cutting the slots 44 so that the space between the strip is significantly larger than merely cutting a line with a laser. In the example shown the space is equal in width to the width of the strips.

An uncut portion at one end forms the lower spine 14 and an uncut portion at the opposite end 40 forms the upper spine 13. The two holes are laser cut into the piece at one end of the upper spine 13 and one at an end of the lower spine 14 nearest the opening 15, in order to create the first and second apertures 8, 9 respectively.

In the conventional methods of forming the three dimensional ornament, the metal is coated with a single colored layer after it is formed and bent to shape. This is normally a powder coat material which is baked on after application of the coating.

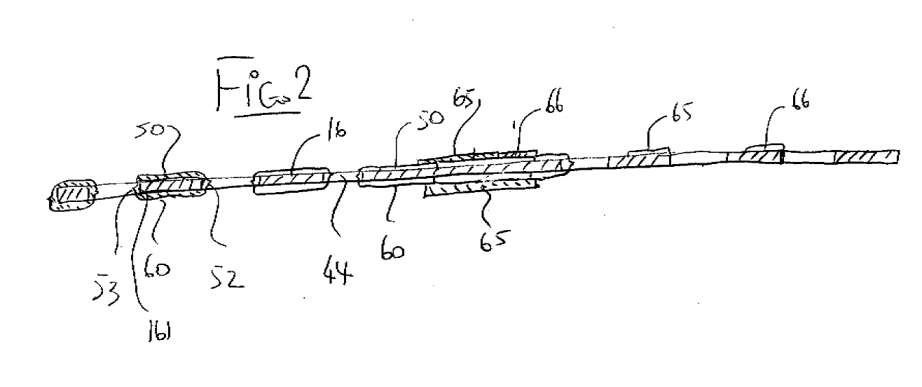

In the present method, while the cut metal sheet remains flat, on each side a respective covering layer 50, 60 of a powder coat material as shown in FIG. 2 is applied onto the cut metal sheet. This coating is then baked so that it is hard.

The coatings 65 and 66 are then applied onto the baked hard coat by silk screen printing process using a conventional ink printing material.

On one side or both sides of the cut metal sheet, the covering layer 65, 66 is printed in at least two separate steps each involving a different color so that the covering layer on said at least one side is formed of different colors 50, 65 and 66 on one side and 60 and 65 on the other side.

The space between each strip and the next is arranged to be sufficient that the coating 50, 60 on each side of the strip meet as indicated at 52 and 53 so as to also cover edges 161 of the strips 16 at the space 44.

The space between each strip and the next is arranged to be sufficient that the printed the covering layers on the each strip 16 are separated from the covering layers on the next adjacent strip by the space 44 between the strips.

After the coatings are applied and baked to effect the curing action so that the coatings are hard and permanent and the printed layer or layers applied, at least some of the strips are bent out of the flat plane of the metal sheet at an area 70 of bending of the strips to form a three dimensional ornament as described above.

The width of each strip at the area 70 of bending of the strip is arranged by cutting out sufficient material at the space 44 such the bending occurs without cracking the covering layers. That is the width of the strip in the bend area is such that the bend can be controlled to smoothly curve through the bend line rather than form a sharp bend angle. Thus the radius of curvature of the bend is increased by reducing the width of the strip to be bent so that the bending occurs more easily and allows the larger radius of curvature to be formed.

The area where the additional colors are formed is preferably in the central flat plate area which remains flat and is preferably applied symmetrically on both sides. However the colors can be applied where ever required and in whatever number of different steps for different numbers of colors.

Each strip 16 is then bent out of the plane defined by the flat surface of the two dimensional piece 38 in order to form the angularly spaced arrangement of strips 16 as shown from above in FIG. 2. Dashed line 33 represents the vertical plane from which each strip is angularly displaced by bending the opposing ends 29 and 30 of said strip by an equal amount in the same direction.

The above description outlines a single embodiment of the present invention intended to illustrate the concept of suspending a three-dimensional decorative member for independent rotation within another three-dimensional decorative member. A number of alternate embodiments can be developed base on small modifications that would be obvious to those skilled in the art. In the described embodiment each strip has the same general shape, the same uniform width between its inner and outer edges, the same radial and angular distance to adjacent strips on the same side of the spines and a respective strip on the opposite side of the spines approximately 180 degrees away. Each of these factors can be varied, making a number of other embodiments possible. Each strip can have a different shape, an irregular shape and varying width. The strips can be spaced apart by varying angles and distances and do not have to be paired up across the spines in a 180 degree arrangement. The silhouette of the inner member can be eliminated by having no portions of the inner edge of the innermost strip on each side of the spines jutting inward, thereby leaving only an opening. In this case, a third member could be fabricated and suspended for independent rotation within the inner member in the same fashion as the inner member is suspended within the outer member. Alternatively, the piece of sheet metal used to fabricate the inner member can have no cuts within the outer edge of the innermost strip on each side of the spines, thereby eliminating the opening altogether and having a solid metal shape in the center of the assembly.

In one alternate embodiment, the decorative assembly can be suspended for rotation about a horizontal axis. The assembly 1 would then be rotated 90 degrees from the orientation shown in FIG. 1 such that the spines are aligned along a horizontal axis rather than a vertical one. The assembly would then be suspended between a pair of hooks or other supporting devices arranged one on each side of said assembly.

Further embodiments may feature inner and outer members of the decorative assembly of the type described in the above published application of the present Applicants.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of manufacturing a decorative assembly comprising:
providing a flat sheet of metal;
cutting from the metal portions of the metal so as to form strips of the metal separated each from the next by a space from which the metal has been removed;
while the cut metal sheet remains flat, applying onto the cut metal sheet on each side a respective covering layer;
on at least one side of the cut metal sheet the covering layer being applied in at least two separate steps each involving a different color so that the covering layer on said at least one side is formed of different colors;
the space between each strip and the next being sufficient that the printed covering layers on each side of the strip meet so as to also cover edges of the strips at the space with the covering layers on the each strip being separated from the covering layers on the next adjacent strip by the space between the strips;
bending at least some of the strips out of the flat plane of the metal sheet at an area of bending of the strips to form a three dimensional ornament;
wherein the width of each strip at the area of bending of the strip is arranged such the bending occurs without cracking the covering layers.

2. The method according to claim 1 wherein the coatings include a powder coat layer and a colored layer which is applied by silk screen printing process onto the powder coat layer.

3. The method according to claim 2 wherein the powder coat layer is baked prior to application of the colored layer by the silk screen process.

4. The method according to claim 1 wherein on both sides the covering layer is coated in at least two separate steps each involving a different color so that the covering layer on said at least one side is formed of different colors.

5. The method according to claim 1 wherein the flat sheet of metal is cut to form a member comprising:
a first spine having an axis, a first aperture near an outer end and a second aperture near an inner end;
a second spine having the same axis as the first spine;
a first series of progressively longer angularly spaced strips each having an inner edge, an outer edge and two opposite ends, each end connected to a respective one of the spines on a first side; and
a second series of progressively longer angularly spaced strips each having an inner edge, an outer edge and two opposite ends, each end connected to a respective one of the spines on a second side;
wherein the strips in each series are spaced apart by the space between the inner edge of one of said strips and the outer edge of an adjacent one of said strips; and
wherein the inner edge of the strip of shortest length in the first series and the inner edge of the strip of shortest length in the second series define an opening in the outer member.

6. The method according to claim 5 wherein the two spines are connected to and separate by a center panel which is maintained flat.

7. The method according to claim 6 wherein the center panel contains different colors.

8. The method according to claim 5 wherein adjacent strips of the first series are angularly spaced by a generally equal first angle and adjacent strips of the second series are angularly spaced by a generally equal second angle.

9. The method according to claim 8 wherein the first and second angles of the inner member are generally equal.

10. The method according to claim 5 wherein each strip in the first series is angularly spaced from a respective strip in the second series of the inner member by about 180 degrees.
